(19) United States
(12) Patent Application Publication
(10) Pub. No.: US 2026/0124630 A1
(43) Pub. Date: May 7, 2026

(54) PUMP MODULE, DISCHARGE HEAD AND FLUID DISPENSER

(71) Applicant: Aptar Villingen GmbH, Villingen-Schwenningen (DE)

(72) Inventors: Karlheinz HUMMEL, Gütenbach (DE); Peter SUESS, Königsfeld (DE); Olivier LECOMTE, Argueil (FR); Stéphane GATIER, Sausanne (FR)

(21) Appl. No.: 19/107,291

(22) PCT Filed: Aug. 29, 2023
(86) PCT No.: PCT/EP2023/073726

§ 371 Date: Feb. 27, 2025

(30) Foreign Application Priority Data
Aug. 31, 2022 (EP) 22193057.1

(51) Int. Cl. B05B 11/10

(52) U.S. Cl. CPC B05B 11/1074; B05B 11/1077

(57) ABSTRACT

A pump module comprising a pump cylinder having a fluid inlet, an inlet valve, a stem and a piston attached to the stem and within the pump cylinder and defining a pump chamber together with the pump cylinder, the stem extending out of the pump cylinder and comprising an outlet channel. The pump module comprises a return spring wherein the stem and the piston are pressed in the direction of the unactuated end position, the return spring. A ventilation path through which an interior space of the return spring is connected to a surrounding atmosphere runs at least partially through at least one ventilation aperture or at least one end-side recess in the return spring and/or through at least one ventilation channel or at least one ventilation groove in the support collar attached to the pump cylinder.

### FIELD OF APPLICATION AND STATE OF THE ART

The invention relates to a pump module for usage as part of a fluid dispenser as well as to a discharge head and a fluid dispenser containing such a pump module. A pump module according to the invention is being used for example in fluid dispensers for skin lotions as well as in fluid dispensers for other cosmetic products or pharmaceutical liquids.

Pump modules of this type are intended to be combined with a liquid reservoir. A pump stem with a piston is movable in a pump cylinder of the pump module. An applicator unit is attached to the stem, said applicator unit having a discharge opening. When the applicator unit is pressed down, the stem and a piston attached thereto are pressed into a pump chamber of the pump module. The pump chamber is thereby reduced in size and liquid from the pump chamber flows through an outlet channel in the stem to the applicator unit and is discharged here through the at least one discharge opening.

The return force to push the stem and the piston back to the initial position after actuation is achieved in classic pump modules by means of a metallic helical spring, which acts between the applicator unit and the pump cylinder.

To improve the recycling of such a pump module, it is known to design the return spring as a plastic spring. Besides plastic coil springs, various circumferentially closed springs have been proposed, which at least substantially separate a spring interior from an outer environment. Such springs also include bellows springs and dome-shaped springs. Pump modules with such springs are known from documents WO 2021/206255 A1 and U.S. Pat. No. 10,335,816 B1, for example.

Although such closed springs provide very good return characteristics, they have the disadvantage that the air in their interior is compressed or decompressed by the deformation during the pressing down and return movement of the applicator unit and thus negatively influences the spring characteristics. Furthermore, such a closed spring makes it more difficult to ventilate a bottle interior of the liquid dispenser.

### OBJECT OF THE INVENTION

The object of the invention is to provide a pump module of the above-mentioned type which, despite the use of a circumferentially closed spring, prevents excessive positive pressure or excessive negative pressure within the closed spring during downstroke and backstroke of the pump piston and, if the pump module is suitably designed, also enables the ventilation of a liquid reservoir through the pump module.

In order to fulfill this a pump module is being proposed comprising a pump cylinder having a fluid inlet and an inlet valve at one end. The pump module further comprises a stem and a piston which is attached to the stem. The piston is located within the pump cylinder and defines a pump chamber together with the pump cylinder. The stem extends out of the pump cylinder and comprises an outlet channel of the pump module. The stem and the piston are movable relative to the pump cylinder from an unactuated end position with maximum volume of the pump chamber to an actuated end position with minimum volume of the pump chamber in order to press fluid out of the pump chamber into the outlet channel surrounded by the stem. The fluid is led to the applicator unit and dispensed through the at least one dispensing opening of the applicator unit.

Usually, the pump module comprises an outlet valve being located downstream of the pump chamber. In an advantageous embodiment said outlet valve is being provided by the piston being movable in a limited way relatively to the stem. Depending on the relative position of the piston relative to the stem the pump chamber is connected to or separated from the outlet channel inside the stem. When the stem is pressed downwardly in the direction of the pump chamber the piston is shifted relative to the stem to open the outlet channel. During the backstroke the negative pressure in the pump chamber leads to an opposite shifting of the piston relative to the stem, thus closing the outlet valve and the outlet channel.

The pump module comprises a return spring in the form of an essentially circumferentially closed spring surrounding the stem. In particular this closed spring can be a bellows spring or a dome-shaped spring. The closed spring acts as return spring and presses the stem and the piston in the direction of the unactuated end position.

The closed spring is supported with a first end surface by the stem, or a support collar fixedly attached to the stem, said collar not being part of the applicator unit being connected to the stem. It is however preferred that it is the stem itself and therefore in particular the exact element extending into the pump cylinder which directly supports the outer first end surface of the closed spring. A second end surface on the opposite side of the closed spring is supported by the pump cylinder or by a support collar fixedly attached to the pump cylinder. In particular the second end can be supported by collar being fixed at the upper open end of the pump cylinder.

Due to the fact the closed spring is supported on both sides, specific methods are needed for the ventilation of the closed spring interior space. According to the invention a ventilation path is provided, through which an interior space of the closed spring, in particular of a bellows spring or of a dome-shaped spring is connected to a surrounding atmosphere.

According to a first variant said ventilation path runs at least partially through at least one ventilation aperture or at least one end-side recess in the closed spring, in particular in an end region of the bellows spring or of the dome-shaped spring.

According to a second variant the ventilation path runs through at least one ventilation channel or at least one ventilation groove in the support collar attached to the pump cylinder.

Both variants allow an easy air exchange between the interior space of the essentially closed spring and the outside atmosphere. In order to provide a total ventilation path being sufficiently wide the different approaches can be combined. For example, ventilation channels in both the closed spring itself as well as in the support collar can be combined.

The essentially closed spring is preferably designed as a bellows spring. In a bellows part of this bellows spring a helical fold protrusion or a plurality of annular fold protrusions are provided which allow the length of the bellows spring to be changed when the bellows spring is compressed elastically.

In a preferred embodiment according to the above listed first variant the bellows spring has an annular end surface interrupted by at least one recess to form the ventilation path. The at least one recess extends from a closed spring interior space to the outer side of the closed spring, thus allowing air to use those recesses as ventilation path. If the closed spring is shortened by pressing down the applicator unit, the air inside the closed spring is expelled though the at least one recess. If the application of force pressing down the applicator unit and compressing the closed spring ends, the inherent restoration of the elastically deformed closed springs lengthens the spring again and presses the stem in its original position again while the interior space of the spring gets larger, and air is being sucked inside through the at least one recess.

The appropriate number and size of the recesses depends on the inner volume of the closed spring. Usually, a number of 2 to 6 recesses and a summarized cross section of all recesses together of 4 mm² to 30 mm² has found out to be a good compromise between a sufficient broad ventilation path and the maintenance of a sufficient stability of the closed spring.

As the annular end surfaces of the closed spring are needed for supporting the closed spring, it is preferred that the annular end surface is interrupted by the recesses to a maximum of 30% of its circumference, preferably to a maximum of 20%. If larger recesses are needed for allowing more air to be expelled and/or sucked in quickly, it is preferred to design the closed spring's end with a large wall thickness. In particular, the bellows spring preferably has an end collar at the end on which the end surface with at least one recess is provided, the end collar having a wall thickness which is larger than the wall thickness of a longitudinal center part of the closed spring, in particular of a deformable bellows part of the bellows spring, preferably the wall thickness of said end collar being at least twice as large as the wall thickness in the center part or bellows part.

If large recesses are provided on the annular end surface of the bellows spring or the dome-shaped spring it can be advantageous to provide means for preventing the interrupted annular surface from folding outwardly. Therefore, it can be helpful that the pump module comprises a support surface for supporting the interrupted end surface of the spring, said support surface comprising an outer retaining wall which prevents or limits radial expansion of the bellows spring or the dome-shaped spring in the region of the support surface. In particular, the support surface for supporting the interrupted end surface can be provided on a support collar attached to the pump cylinder.

The at least one end-side recess in the end surface of the bellows spring or the dome-shaped spring can have a cross section of unitary size. However, it has been found out that it can be an advantage to design the at least one recess such that the cross section of the recess is tapering from the bellows spring or dome-shaped spring inner side to its outer side. The tapering design of the recess facilitate the outflow of air when the spring is being compressed while still providing more stability to the spring than a spring with non-tapering recesses of relatively large size.

While recesses on at least one of the end surfaces of a bellows spring or a dome shaped spring provide a good possibility to expel air during spring compression, it can be a good alternative to provide at least one ventilation aperture through the bellows spring's wall or through the dome-shaped spring's wall instead. Such a ventilation aperture is designed as a through hole circumferentially surrounded by material of the essentially closed spring.

The use of such a design with at least one through hole aperture means that the end surface of the spring does not have to be interrupted by recesses and therefore ensures greater stability. In particular, if a relatively broad ventilation path is required, a design with recesses in the end surface of the closed spring may represent a critical weakening. In such a case, a ventilation aperture or a plurality of ventilation apertures may be a better approach.

A bellows spring usually has a center or center bellows part with the folding protrusions and a collar at both ends. When the bellows spring is being compressed, this compression takes place only or primarily in the center bellows part while the end-side collars of the bellows spring are not or less deformed.

It is possible to provide the at least one ventilation apertures in the bellows part. However, as the bellows part is primarily deformed and as the behavior of this part could be negatively influenced by the apertures it is preferred that at least one ventilation aperture is provided in a bellows collar of the bellows spring at one end of the bellows spring. In relation to the length of the spring, the at least one ventilation aperture is preferably provided in an end section of the spring, the length of which corresponds to 10% of the total spring length in relaxed state.

Bellows springs are typically manufactured by injection molding using two slides that define the outer contour of the bellows spring, and by using an inner core defining the inner contour of the bellows spring. After injection and solidification of the material, the slides are shifted away from the core in opposite directions for subsequent demolding.

As it is advantageously to define the apertures by protrusions provided on the slides and as there are moved in opposite directions during demolding of the bellows spring, in case of multiple ventilation apertures it is preferred that these ventilation apertures have parallel directions of extension for easy demolding, even if the direction of extension of some of the ventilations apertures differs from a radial direction.

The demolding of bellows springs is usually conducted using air to separate the bellows spring from the core defining the inner contour. In order not to avoid that the air for separation exits the bellows spring through the ventilation openings during demolding, it is preferred that the ventilation apertures or the recesses are provided on the opposite end and in particular in the bellows collar at the opposite end. Usually bellows springs have a demolding rim on the side from which the separation air is provided. Thus, the ventilation apertures or recesses are preferably provided on the opposite end while the bellows collar on the side of the demolding ring is not interrupted by recesses or by ventilation apertures.

As initially listed the ventilation path can not only be provided in the bellows spring or the dome-shaped spring. Additionally, or instead, it is also possible to provide the pump module with a support collar on the pump cylinder having a support surface on an upper side for support of the bellows spring or the dome-shaped spring. This support collar can also be used to provide the ventilation path.

Like the bellows spring or the dome-shaped spring, the ventilation path in said support collar can be provided in the form of grooves or in the form of apertures being designed as through holes.

In case of a support collar with at least one groove, said groove is being provided in the contact surface, wherein in the region of said groove the end surface of the bellows spring or of the dome-shaped spring does not bear against the support collar. Preferably, a plurality of grooves is provided in the contact surface of the support collar, preferably between 2 and 6 grooves.

In a preferred embodiment, an outer retaining wall is provided on the outside of the support surface for holding a lower end collar of the bellows spring or the dome spring being located within said outer retaining wall. This outer retaining wall supports the spring at its lower end and prevents it from breaking out.

In principle, it is possible to make this retaining wall circumferentially closed. In this case, the air flowing through the grooves in the supporting surface can flow upwards on the inside of the outer retaining wall and into the surroundings. However, this requires that a gap remains at least partially between the outside of the bellows spring or dome spring and the inside of the retaining wall.

In contrast, an advantageous design provides that the at least one groove and preferably the plurality of grooves extend into and through the outer retaining wall. Air can thus be exchanged between an inner region of the spring and a surrounding atmosphere with lower flow resistance.

Preferably, the groove in the region of the support surface and in the region of the retaining wall has a groove base that is uniformly parallel to the support surface. This facilitates the manufacture of the injection molds for the production of the components.

The outer retaining wall is preferably provided with an internal inlet slope, which facilitates insertion of the lower collar of the spring during assembly. In particular, it is advantageous if the lower collar rests against the inside of the retaining wall in a circumferential manner, with the exception of the areas of the grooves, and is preferably held here in a clamping manner. In particular for such an embodiment, the provision of an inlet slope is very advantageous.

The outer retaining wall does not need be closed circumferentially except for the area of the grooves but can also be formed by a crown structure with a plurality of distinct retaining segments. Preferably, however, the outer retaining wall is designed as a circumferential wall which is only interrupted in the area of the grooves. The at least one groove or the plurality of grooves summed up spans a maximum of 20% of the wall circumference.

In case of at least one ventilation channel being provided the support collar, said ventilation channel or ventilation channels penetrate the support collar. The one end of such a ventilation channel is provided on the inner side of the support collar adjacent to the bellows spring's inner space or dome-shaped spring's inner space while the second end of the ventilation channel is provided on the outer side of the support collar.

Using the support collar for ventilation has the advantage that the spring element, in particular the bellows spring, can be left unamended and fully closed. Therefore, bellows springs proven in the past can be used without any adaptation.

Besides the pump module itself, the invention also relates to the discharge head. This discharge head comprises a pump module of the type described above and a base for attachment to a liquid reservoir. Said base can be integrally formed with the pump cylinder, but a design is preferred with separate components for the base and the pump cylinder being connected with each other. Furthermore, the discharge head comprises an applicator unit having the discharge opening, for example a discharge opening to discharge the liquid in form of a jet or in form of a spray cone. Said discharge head is being connected to the stem of the pump module in order to be pressed down and thus to compress the fluid in the pump chamber.

The applicator is being connected with the stem in order to actuate the pump module. However, it is important to mention that the applicator unit does not have the task to support the closed spring. The spring is being supported by parts of the pump module itself, not by additional parts like the applicator unit.

The invention relates to a fluid dispenser for dispensing a fluid, in particular for dispensing a cosmetic product. Said fluid dispenser comprises a fluid reservoir, preferably a fluid reservoir with a volume of 500 ml or less in which a cosmetic fluid is being stored. The fluid dispenser further comprises a discharge head having a pump module. Said pump module is designed as pump module according to the description above.

### BRIEF DESCRIPTION OF THE DRAWINGS

Further advantages and aspects of the invention are described and shown in the claims and in the following description of preferred embodiments of the invention, which are explained below with reference to the figures.

FIG. 1 shows a fluid dispenser having a pump module according to the invention.

FIGS. 2 and 3 show the pump module with a bellows spring in a perspective view as well as in a sectional view.

FIGS. 4 and 5 show a first variant of the ventilation of the bellows spring.

FIG. 6 shows a second variant of the ventilation of the bellows spring.

FIG. 7 shows a third variant of the ventilation of the bellows spring.

FIG. 8 shows a fourth variant of the ventilation of the bellows spring.

FIG. 9 shows a fifth variant of the ventilation of the bellows spring.

FIG. 10 and FIG. 11 show the pump module according to the invention with different spring types, namely a bellows spring and a dome-shaped spring.

FIG. 12 to 15 shows a further version of a pump module according to the invention.

### DETAILED DESCRIPTION OF THE EMBODIMENTS

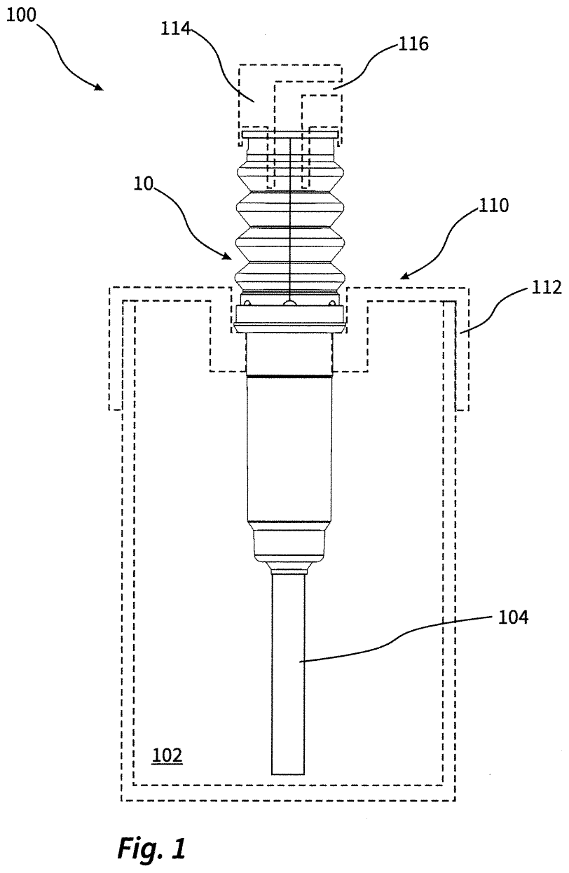

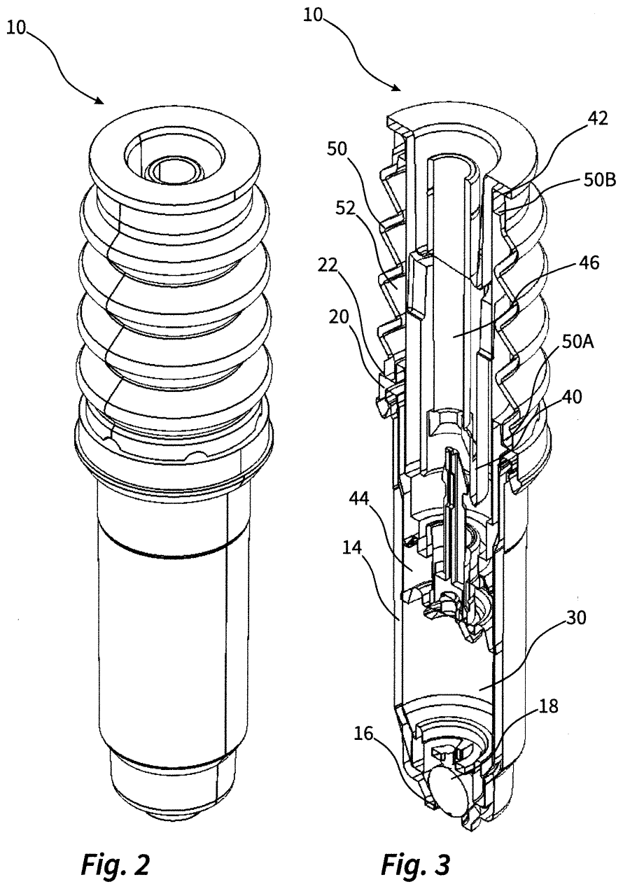

FIG. 1 shows a liquid dispenser 100 for dispensing liquids, in particular for dispensing cosmetic liquids such as soap, body lotions and the like having a pump module 10. FIG. 2 and FIG. 3 show the pump module 10 in separate views wherein FIG. 3 shows a sectional view thereof.

The liquid dispenser 100 has a liquid reservoir 102 with a cup-shaped structure in which the liquid is stored prior to discharge. Preferably, the fluid reservoir 102 has an internal volume of 200 ml or less. The fluid reservoir shown in FIG. 1 is a vented fluid reservoir, i.e., air is entering the fluid reservoir after fluid has been discharged to avoid negative pressure in the reservoir. As an alternative the fluid reservoir could be of flexible volume, e.g., by having a fluid reservoir using a flexible bag or a follower piston.

The liquid dispenser 100 further comprises a discharge head 110, which comprises a base 112, a pump module 10 and a discharge unit 114. The base 112 forms a cover for the fluid reservoir 102 and a support for the pump module 10. In the example, the pump module 10 is coupled to the base 112, for example attached by means of a snap connection or a threaded connection. However, it is also possible to design the base 112 integrally with a part of the pump module 10, in particular integrally with a pump cylinder 14 of the pump module 10.

In addition to the aforementioned pump cylinder 14, the pump module 10, which will be described in further detail below, has a stem 40 that projects into the pump cylinder 14 from above and has a piston 44 attached to its lower end. The stem 40 extends upwardly out of the pump cylinder 14 and forms a support for the discharge unit 114, which may be attached to the upper end of the stem 40 by means of a screw or snap connection, for example. Fluid expelled from the pump module 10 goes through an outlet channel 46 in the stem 40 to reach the discharge unit 114.

The discharge unit 114 has a discharge opening 116, which is shown in simplified form in the figures. However, the discharge opening 116 can also be designed with more complex geometries, with fine nozzle openings or an outlet valve in order to influence the discharge and, for example, in order to produce a spray jet.

The pump module 10 has the aforementioned pump cylinder 14, which projects into the fluid reservoir 102 and at the lower end of which a fluid inlet 16 is provided. Preferably, the fluid inlet 16 is preceded by a dip tube 104 which extends into a bottom region of the fluid reservoir 102. An inlet valve 18 is provided at the fluid inlet 16, which in the illustrated embodiment is implemented via a ball valve which includes a movable ball which closes the fluid inlet 16 in the event of positive pressure in the pump cylinder 14 in order to allow discharge and which opens in the event of negative pressure in the pump cylinder 14 in order to allow inflow of fluid into the pump cylinder 14 from the reservoir 102.

The movable piston 44 is arranged inside the pump cylinder 14. In the present case, the piston is formed primarily by a piston sleeve, which is attached to the stem 40 in a limitedly movable manner. Together with the pump cylinder 14, the piston 44 delimits a pump chamber 30, which is reduced in size during fluid discharge, and which is enlarged for the purpose of subsequent liquid suction from the fluid reservoir during backstroke of the stem 40 and the piston 44.

The piston 44 is movably attached to the stem 40 to prevent and to allow a discharge of fluid from the pump chamber 30 into the outlet channel 46 leading to the applicator unit 114. When the stem 40 is pressed down, the piston 44 is displaced upwardly relative to the stem 40 to allow fluid to flow from the pump chamber 30 into the outlet channel 46 and to the discharge opening 116. As the stem 40 is displaced upwardly during the return stroke, at the beginning of this movement, the piston 44 is displaced relative to the stem to a lower end position isolating the pump chamber 30 from the outlet channel 46 so as to create a negative pressure in the pump chamber 30 which opens the inlet valve 18 and draws fluid from the fluid reservoir 102 into the pump chamber 30.

The pump module 10 is designed with ease of recycling in mind. Thus, it preferably comprises only plastic parts, preferably plastic parts that can be handled in a single recycling stream.

In particular, the pump module has a plastic return spring 50 instead of a metallic return spring. This plastic return spring 50 is designed as a substantially closed hose-like spring that can be axially compressed against a return force. The return spring 50 is arranged surrounding a central part of the stem 40 between the pump cylinder 14 or a support collar 20 attached thereto on the one hand and an upper end region of the stem 40 on the other hand and is supported at the ends by the said components.

Since support surfaces 22, 42 for supporting the return spring 50 at both ends are thus a direct part of the pump module 10, the latter can be easily handled during assembly. The fact that the return spring 50 is a quasi-internal part of the pump module 10 facilitates the assembly of the pump module 10, the fluid reservoir 102 and the discharge unit 114 as the return spring 50 does not have to be handled separately during assembly of the dispenser 100.

The design of the return spring 50 as a circumferentially closed spring results in a comparatively large achievable return force and a good reproducible behavior of the spring. In the present embodiment, the return spring 50 is designed as a bellows spring, which has helical or circumferential fold-like protrusions in a center bellows part 50C, said protrusions being brought closer to each other when the stem 40 is pressed down and are elastically deformed in the process. Bellows end collars 50A, 50B are provided at both ends of the bellows spring 50, said bellows collars being comparatively thick and are thus not deformed or hardly deformed when the spring 50 is being compressed. Instead of being a bellows spring 50, the return spring can also have another design of a substantially closed spring. In particular, a dome-shaped spring is an alternative.

Due to the substantially circumferentially closed shape of the return spring 50, the latter encloses an annular inner space 52 which is limited on the outside by the return spring 50 and on the inside by an outer side of the stem 40. The air located therein is compressed when the piston 44 is pressed down. During the upward movement of the stem 40, said interior space is enlarged so that a negative pressure is created therein.

This positive pressure during depressing and the negative pressure during backstroke constitute a disadvantage since they potentially influence the spring behavior of the return spring 50 negatively. It is therefore provided that the inner space 52 of the return spring 50 is communicatively connected via a ventilation path to an environment outside the pump module 10 and outside the fluid dispenser 100. This not only serves to allow air to flow out of and into the interior space 52 of the return spring 50, but instead, in the case of fluid dispensers with vented fluid reservoirs like the one of FIG. 1, this communicating connection may also serve to ventilate the bottle.

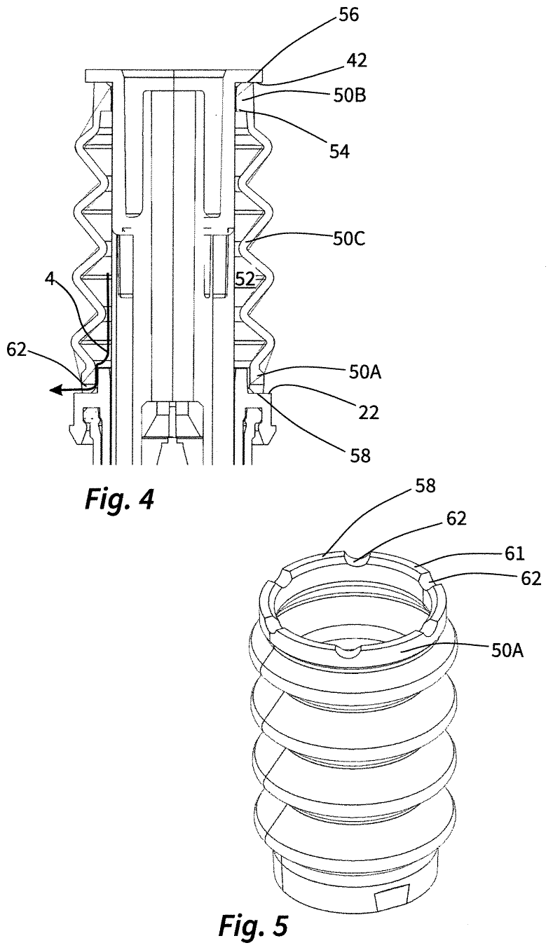

FIGS. 4 and 5 illustrate a first variant for achieving a ventilation connection between a surrounding atmosphere and a spring interior space 52. Here, it is provided that recesses 62 are made in an end surface 58 on the lower bellows collar 50B of the return spring 50. In this case a total of six recesses which are offset from one another by 60° are proposed. Between the radial recesses 62 there remain support areas 61 with which the bellows spring rests on the support surface 22. The recesses 62 reduce the support surface by only about 25%. It may be useful to design the bellows collar 50A with a greater width to compensate for this.

As illustrated by FIG. 4, air can escape via the ventilation path 4 from the spring interior space 52 through the recesses 62 when the stem 40 is depressed.

In principle, it would also be possible to provide the recesses 62 not only at the lower bellows collar 50A, but instead or additionally at the upper bellows collar 50B of the bellows spring 50. However, this is considered disadvantageous in the present case for the following reason. The manufacture of a closed spring for use in the present invention is typically accomplished by an injection molding process in which an inner core keeps the interior of the spring free of material. Detachment of the spring after solidification of the material is usually accomplished by means of air. However, if recesses or openings are provided at both ends of the return spring, it is difficult to supply air between said core and the return spring to enable the return spring to be demolded. Preferably, therefore, recesses 62 or the ventilation apertures 64 are provided only on one end face or in one end region of the return spring 50. The recesses 62 are preferably provided on the side opposite to the spring side comprising a demolding rim 54.

Due to the shape of the bellows collar 50A and the support collar 20, which is attached to the pump cylinder 14, the flow resistance through the recesses 62 is comparatively large. This can result in air not being able to escape from the spring interior space 52 to the desired extent during the short period of actuation or not being able to flow in sufficiently quick during the return stroke.

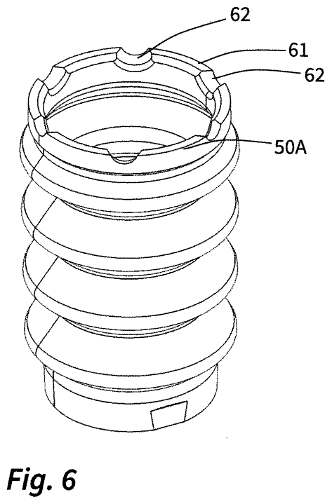

FIG. 6 shows a design in which the recesses 62 have a modified shape to improve the flow behavior of the air. The recesses 62 here are widening inwardly. It has been found out that despite the fact that their most narrow cross-section is unchanged compared to the design of FIG. 5, this widening achieves a significantly improved outflow of air from the spring interior space 52 of the spring during the depression of the stem 40.

In many applications, the design with the recesses 62 on one of the end surfaces 56, 58 of the closed spring 50 is perceived as a good way to allow venting of the return spring 50. Nevertheless, providing the recesses in the end face 56, 58 can be a disadvantage, as this reduces the contact area of the return spring and destabilizes the spring 50.

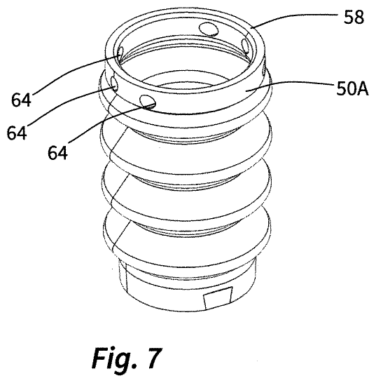

An alternative is therefore designed as shown in FIG. 7. Here, no recesses 62 are provided in the end face 58. Instead, a total of six ventilation apertures 64 are provided in the lower bellows collar 50A, i.e., through-holes that are surrounded by material of the return spring 50. The annular end surface 58 of the return spring 50 is thus uninterrupted.

The ventilation apertures can each have different directions of extension. Preferably, however, they are aligned parallel to each other. Such a uniform alignment allows easy production, since the ventilation apertures 64 can be kept free during injection molding by pins which are provided on two lateral slides of the injection molding tool which are spaced from the core of the injection mold in opposite directions during demolding.

FIGS. 8 and 9 show alternative designs of the ventilation path. Here, it is provided that the support collar 20, which is attached to the upper end of the pump cylinder 14, has a shape by which this ventilation path is created.

In the case of the design of FIG. 8, a ventilation groove 26 is provided in the support collar 20, which breaks through the support surface 22 of support collar 20. The illustrated design is provided with only one ventilation groove 26. Instead, several such ventilation grooves 26 could also be provided, preferably three or more grooves 26 evenly distributed around the circumference. Although similar to the design of FIGS. 5 and 6 this reduces the contact area between the supporting surface 22 and the end surface 58 of the return spring 50, the design with ventilation grooves 26 in the support collar 20 can be advantageous because the deformation of the return spring 50 itself is unaffected by the ventilation grooves 26. Thus, a standard bellows spring can be used without modifications.

FIG. 9 shows an alternative in which ventilation is also provided by the support collar 20. However, it is provided here that no ventilations groove on the upper side is provided, but instead at least one ventilation channel 24 designed as a through hole. Instead of a single ventilation channel 24 multiple ventilation channels 24 may be provided. For ease of manufacture, the ventilation channels 24 are preferably aligned parallel to one another in case multiple ventilation channels 24 are provided.

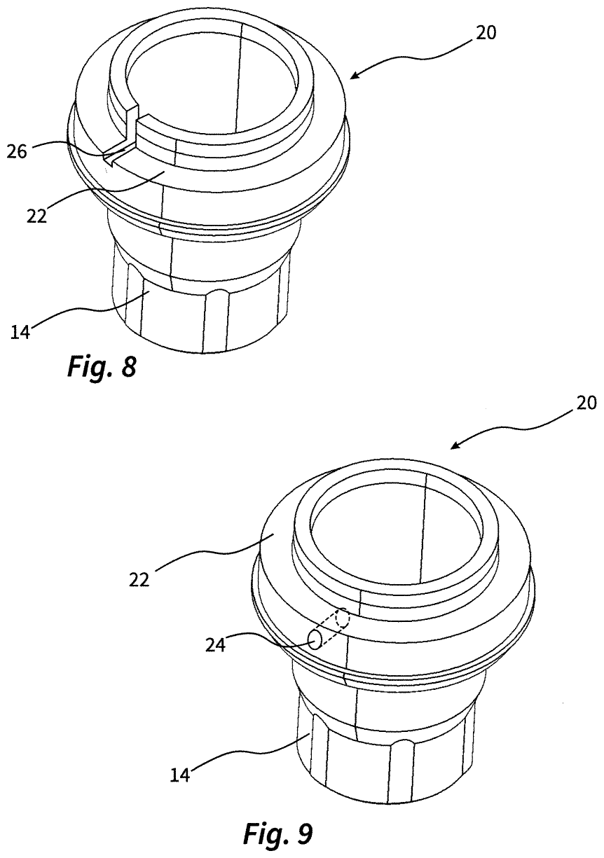

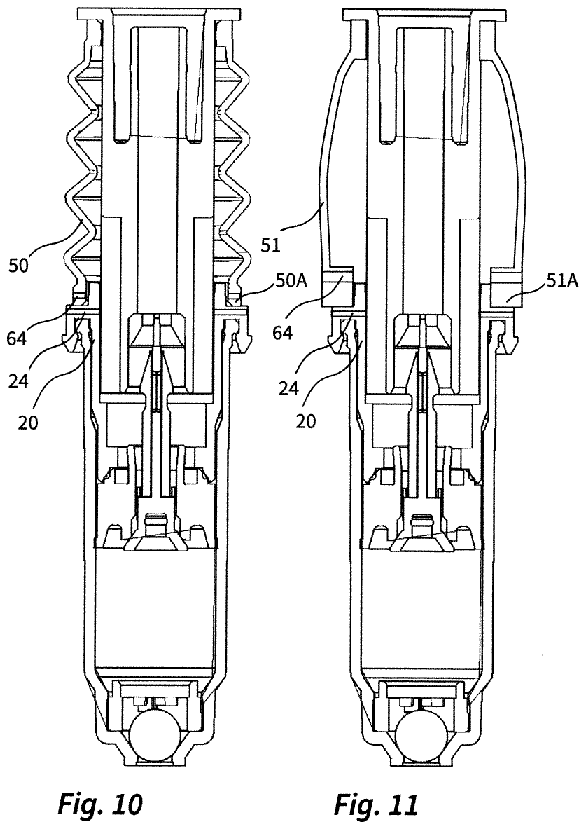

FIG. 10 again shows a pump module 10 with a bellows spring 50 in a sectional view. In the design shown, ventilation apertures 64 and ventilation channels 24 are provided in the bellows spring 50 and in the support collar 20 for the purpose of ventilation.

FIG. 11 illustrates that the concept of ventilation according to the invention is not limited to bellows springs. In the design of FIG. 11, a dome-shaped spring 51 is used instead. Like the bellows spring 50 of FIG. 10, both the support collar 20 and a spring collar 51A at the lower end of the spring 51 are provided with ventilation apertures 64 and ventilation channels 24 here.

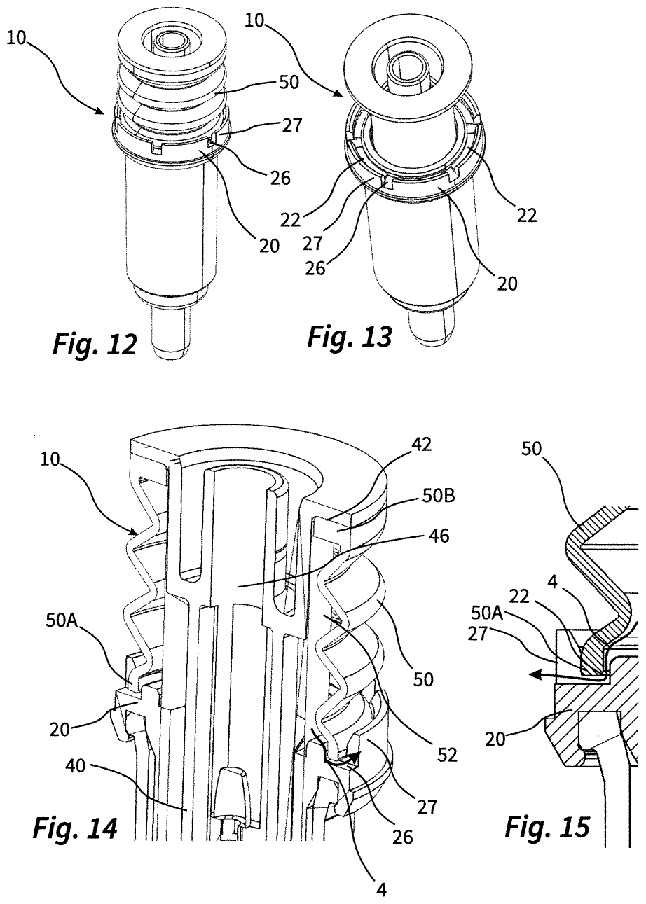

FIGS. 12 to 15 show a further embodiment of a pump module 10 according to the invention. As in the design of FIG. 8, this variant of FIG. 12 to 15 is provided with grooves 26 in the supporting surface 22. In the variant shown, six such grooves 26 are provided, but there could also be more or fewer grooves. A design with only one single groove 26 as in FIG. 8 is also possible.

FIG. 12 shows the full pump module 10. In FIG. 13 the bellows spring 50 is hidden for easier recognition of the grooves 26. FIG. 14 shows a sectional view of the upper part of the pump module 10 and FIG. 15 provides another sectional view of an airflow path 4 in detail.

A relevant feature of the variant according to FIGS. 12 to 15 is that an outer retaining wall 27 is provided on the outside of the supporting surface 22. By said outer retaining wall 27 the lower end collar 50A of the return spring 50 is supported on the outside. The grooves 26 extend through the outer retaining wall 27 in order to allow easy airflow between the inner space 52 of the return spring 50 and the environment.

As an alternative to the upwardly open grooves, through holes can also be provided in the outer retaining wall 27 which break through the retaining collar and are in communication with the grooves 26 in the supporting surface 22.

The outer retaining wall 27 is adapted in such a way that the lower end collar 50A rests against it circumferentially with its outer circumferential face or only a narrow gap remains here. Preferably and in case of the variant according to FIG. 12 to 15 the lower end collar 50A is fixed in a clamping manner by the outer retaining wall 27. In order to facilitate assembly, the upper end of the outer retaining wall 27 is provided with an inlet slope on its inner side.

In a variant not shown in which a gap remains between the outer side of the end collar 50A and the inner side of the outer retaining wall 27, it is preferred that the clear width of said gab is smaller than the clear width on the inside of the bellows collar 50A with the return spring 50 being in centered position.

FIGS. 14 and 15 show the path 4 along which air can be exchanged between an inner space 52 of the return spring 50 and an outer environment. With the small flow resistance provided by said path 4 and with six of those grooves 26 it is ensured that the air can easily escape when the bellows spring 50 is compressed.

1. A pump module for a liquid dispenser, the pump module comprising:
a pump cylinder having a fluid inlet at one end and an inlet valve;
a stem and a piston attached to the stem, the piston being located within the pump cylinder and defining a pump chamber together with the pump cylinder, the stem extending out of the pump cylinder and comprising an outlet channel of the pump module,
the stem and the piston being movable relative to the pump cylinder from an unactuated end position with a maximum volume of the pump chamber to an actuated end position with a minimum volume of the pump chamber in order to press fluid out of the pump chamber into the outlet channel;
a return spring in the form of a bellows spring or a dome-shaped spring by which return spring the stem and the piston are pressed in the direction of the unactuated end position, the bellows spring or the dome-shaped spring being supported with a first end surface by the stem or a support collar fixedly attached to the stem and being supported with a second end surface by the pump cylinder or a support collar fixedly attached to the pump cylinder; and
a ventilation path, through which ventilation path an interior space of the bellows spring or the dome-shaped spring is connected to a surrounding atmosphere, said ventilation path running at least partially through at least one ventilation aperture or at least one end-side recess in the bellows spring or the dome-shaped spring and/or through at least one ventilation channel or at least one ventilation groove in the support collar attached to the pump cylinder.

2. The pump module according to claim 1, wherein
the return spring comprises the bellows spring and
the bellows spring comprises a bellows part, the bellows spring including a helical fold protrusion or a plurality of annular fold protrusions that allow a length of the bellows part to be changed when the bellows spring is compressed.

3. The pump module according to claim 1, wherein
at least one end of the bellows spring or the dome-shaped spring has an annular interrupted end surface, the interrupted end surface being interrupted by at least one recess to form the ventilation path.

4. The pump module according to claim 3, wherein
the pump module comprises a support surface for supporting the interrupted end surface,
the support surface comprises an outer retaining wall, the outer retaining wall preventing or limiting radial expansion of the bellows spring or the dome-shaped spring in a region of the support surface.

5. The pump module according to claim 2, wherein at least one end of the bellows spring has an annular interrupted end surface, the interrupted end surface being interrupted by at least one recess to form the ventilation path,
the pump module comprises a support surface for supporting the interrupted end surface, and
the support surface is provided on a support collar attached to the pump cylinder.

6. The pump module according to claim 3, wherein
a cross section of the at least one recess tapers from an inner side of the bellows spring to an outer side of the bellows spring.

7. The pump module according to claim 1, wherein
the bellows spring or the dome-shaped spring has at least one ventilation aperture circumferentially surrounded by material of the bellows spring or the dome-shaped spring.

8. The pump module according to claim 7, further comprising
a plurality of ventilation apertures in the bellows spring or the dome-shaped spring, the ventilation apertures having parallel directions of extension.

9. The module according to claim 1, wherein at least one and the bellows spring or the dome-shaped spring has an annular interrupted end surface, the interrupted end surface being interrupted by at least one recess to form the ventilation path,
the bellows spring or the dome-shaped spring having at one end an inwardly pointing demolding rim provided at an end opposite the interrupted end surface.

10. The pump module according to claim 1, wherein
the support collar on the pump cylinder has a support surface on an upper side for support of the bellows spring,
the support collar has at least one groove in a contact surface forming a part of the ventilation path, wherein in a region of said groove an end surface of the bellows spring does not bear against the support collar.

11. The pump module according to claim 10, wherein
the support surface comprises an outer retaining wall for holding a lower end collar of the bellows spring or the dome-shaped spring in a region of the support surface, and
the at least one groove penetrates the outer retaining wall.

12. The pump module according to claim 11, wherein
the outer retaining wall comprises an internal inlet slope for inserting the lower end collar of the bellows spring or the dome-shaped spring.

13. The pump module according to claim 11, wherein
the outer retaining wall is configured as a circumferential wall, the circumferential wall only being interrupted in an area of the at least one groove, and
the at least one groove spans a maximum of 20% of a wall circumference of the outer retaining wall.

14. The pump module according to claim 11, wherein
the lower end collar is in circumferential contact with an inner side of the outer retaining wall except in a region of the at least one groove.

15. The pump module according to claim 1, wherein
at least one ventilation channel penetrates the support collar.

16. The pump module according to claim 1,
wherein the piston is movable in a limited way relative to the stem, the piston and the stem together form an outlet valve which can be opened and closed by relative movement of the piston relative to the stem.

17. A discharge head for a liquid dispenser, comprising
a base for attachment to a liquid reservoir;
an applicator unit having a discharge opening, said applicator unit being displaceable relative to the base in a pumping movement; and
the pump module comprising:
a pump cylinder having a fluid inlet at one end and an inlet valve;
a stem and a piston attached to the stem, the piston being located within the pump cylinder and defining a pump chamber together with the pump cylinder, the stem eztending out of the pump cylinder and comprising an outlet channel of the pump module, the stem and the piston being movable relative to the pump cylinder from an unactuated end position with a maximum volume of the pump chamber to an actuated end position with a minimum volume of the pump chamber in order to press fluid out of the pump chamber into the outlet channel;
a return spring in the form of a bellows spring or a dome-shaped spring by which return spring the stem and the piston are pressed in the direction of the unactuated end position, the bellows spring or the dome-shaped spring being supported with a first end surface by the stem of a support collar fixedly attached to the stem and being supported with a second end surface by the pump cylinder or a support collar fixedly attached to the pump cylinder; and
a ventilation path, through which ventilation path an interior space of the bellows spring of the dome-shaped spring is connected to a surrounding atmosphere, said ventilation path running at least partially through at least one ventilation aperture or at least one end-side recess in the bellows spring or the dome-shaped spring and/or through at least one ventilation channel or at least one ventilation groove in the support collar attached to the pump cylinder.

18. A fluid dispenser for dispensing a fluid product, the fluid dispenser comprising:
a fluid reservoir; and
a discharge head comprising a pump module, the pump module comprising:
a pump cylinder having a fluid inlet at one end and an inlet valve;
a stem and a piston attached to the stem, the piston being located within the pump cylinder and defining a pump chamber together with the pump cylinder, the stem extending out of the pump cylinder and comprising an outlet channel of the pump module, the stem and the piston being movable relative to the pump cylinder from an unactuated end position with a maximum volume of the pump chamber to an actuated end position with a minimum volume of the pump chamber in order to press fluid out of the pump chamber into the outlet channel;
a return spring in the form of a bellows spring of a dome-shaped spring by which return spring the stem and the piston are pressed in the direction of the unactuated end position, the bellows spring or the dome-shaped spring being supported with a first end surface by the stem or a support collar fixedly attached to the stem and being supported with a second and surface by the pump cylinder or a support collar fixedly attached to the pump cylinder; and
a ventilation path, through which ventilation path an interior space of the bellows spring or the dome-shaped spring is connected to a surrounding atmosphere, said ventilation path running at least partially through at least one ventilation aperture or at least one end-side recess in the bellows spring or the dome-shaped spring and/or through at least one ventilation channel or at least one ventilation groove in the support collar attached to the pump cylinder.

19. The pump module according to claim 3, wherein:
the bellows spring or the dome-shaped spring has a plurality of recesses interrupting the interrupted end surface; and/or
the interrupted end surface is interrupted by the at least one recess to a maximum of 30% of its circumference; and/or
the bellows spring has a bellows collar at an end on which the interrupted end surface is provided, the bellows collar having a wall thickness larger than a wall thickness of a bellows part of the bellows spring, the wall thickness of the bellows collar being twice as large than the wall thickness in the bellows part.

20. The pump module according to claim 7, wherein:
the bellows spring or the dome-shaped spring has a plurality of ventilation apertures; and/or
the at least one ventilation aperture is provided in a bellows part of the bellows spring; or
the at least one ventilation aperture is provided in a bellows collar of the bellows spring at one end of the bellows spring.

21. The pump module according to claim 10, wherein the support collar has a plurality of grooves in the contact surface.

22. The pump module according to claim 11, wherein in an area of the contact surface and in an area of the outer retaining wall, the at least one groove has a groove base uniformly parallel to the contact surface.
